(19) United States
(12) Patent Application Publication
(10) Pub. No.: US 2003/0104282 A1
(43) Pub. Date: Jun. 5, 2003

(54) In situ thermal polymerization method for making gel polymer lithium ion rechargeable electrochemical cells

(76) Inventors: Weibing Xing, Canton, MA (US); Esther S. Takeuchi, East Amherst, NY (US)

Correspondence Address: Michael F. Scalise, Hodgson Russ LLP, Suite 2000, One M&T Plaza, Buffalo, NY, 14203-2391, US

(21) Appl. No.: 10/000,883

(22) Filed: Nov. 15, 2001

(51) Int. Cl. H01M 10/40; H01M 4/58; H01M 4/66

(52) U.S. Cl. 429/303; 429/189; 429/231.8; 429/245; 429/231.1; 29/623.1

(57) ABSTRACT

A single step, in situ curing method for making gel polymer lithium ion rechargeable cells and batteries is described. This method used a precursor solution consisting of monomers with multiple functionalities such as multiple acryloyl functionalities, a free-radical generating activator, nonaqueous solvents such as ethylene carbonate and propylene carbonate, and a lithium salt such as LiPF₆. The electrodes are prepared by slurry-coating a carbonaceous material such as graphite onto an anode current collector and a lithium transition metal oxide such as LiCoO₂ onto a cathode current collector, respectively. The electrodes, together with a highly porous separator, are then soaked with the polymer electrolyte precursor solution and sealed in a cell package under vacuum. The whole cell package is heated to in situ cure the polymer electrolyte precursor. The resulting lithium ion rechargeable cells with gelled polymer electrolyte demonstrate excellent electrochemical properties such as high efficiency in material utilization, high Coulombic efficiency, good rate capability, and good cyclability.

### BACKGROUND OF THE INVENTION

1. Field of the Invention

This invention relates to electrochemical power sources such as cells and batteries. Specifically, this invention relates to a method for making gel polymer lithium ion rechargeable or secondary cells and batteries. More specifically, the present invention relates to a single step, in situ polymerization method for making gel polymer lithium ion rechargeable cells and batteries.

2. Prior Art

The worldwide demand for portable electronic devices is growing rapidly and is responsible for the increasing need for high density and lightweight electrical energy power sources. To meet this growing demand, lithium ion secondary batteries, particularly rechargeable high energy density flat batteries containing gel polymer electrolytes, have been developed. These electrolyte chemistries comprise liquid plasticizers trapped in a polymer matrix. Gel polymer electrolytes have the following advantages compared with conventional liquid electrolytes: (a) they contain no free-flowing liquid and, therefore, the possibility of electrolyte leakage is eliminated, (b) they provide flexibility for engineering design, especially for flat and thin batteries, and (c) they are safer to use than their liquid counterparts.

Exemplary gel polymer electrolyte cells are described in U.S. Pat. Nos. 5,194,490 to Suga et al.; 5,223,353 to Ohsawa et al.; 5,240,791 to Izuti et al.; 5,356,553 to Kono et al.; 5,417,870 to Andrei et al.; 5,463,179 to Chaloner-Gill et al.; 5,603,982 to Sun; 5,609,974 to Sun; 5,665,490 to Takeuchi et al.; 5,783,331 to Inoue et al.; 5,968,681 to Miura et al.; 5,977,277 to Yokoyama et al.; 6,013,393 to Taniuchi et al.; 6,019,908 to Kono et al.; 6,096,234 to Nakanishi et al. and 6,159,389 to Miura et al., and in Japanese patents 2000-067866A2 to Kuse et al. and 2000-260470A2 to Tetsuo et al.

In particular, U.S. Pat. Nos. 5,603,982 and 5,609,974, both to Sun, which are assigned to the assignee of the present invention and incorporated herein by reference, describe a terpolymer electrolyte system where the first monomer or prepolymer is bi-functional and serves as a cross linking agent. The second monomer is mono-functional with a high polar group such as a carbonate or a cyano group to enhance conductivity. The third monomer is mono-functional with an oligo(oxyethylene) group to provide the resulting polymer with flexibility and free volume for the movement of ions. These monomers are mixed with a lithium salt and organic plasticizers to form a liquid mixture, which is then cast onto a reinforcing separator and cured by heating. The resulting gel solid polymer electrolyte (SPE) is freestanding and useful in flat gel polymer lithium ion electrochemical cells. Negative and positive electrodes are prepared from anode and cathode active powders, a binder and carbonaceous conductive materials soaked in an electrolyte of a lithium salt and organic solvents and hot pressed to respective copper and aluminum current collector foils.

Japanese Patent Nos. 2000-067866A2 to Kuse et al. and 2000-260470A2 to Tetsuo et al. describe the development of a gel polymer electrolyte where a multi-functional monomer is mixed with a lithium salt and organic plasticizers. A separator is soaked in this solution while electrodes are prepared by coating active slurries onto respective negative and positive current collector foils. Electrolyte soaked electrodes and the separator are then cured under an ultraviolet light or an electron beam. After curing, the electrodes and the SPE are assembled into a stack as a flat gel polymer lithium ion cell.

In the above patents, the SPE is cured either separately or with one of the electrodes. This means that there are production inefficiencies inherent in their processes. Development of a single step polymerization method for making gel polymer lithium ion cells is necessary to simplify battery production processes and, consequently, to improve production efficiencies and reduce production costs.

### SUMMARY OF THE INVENTION

In the present invention, a single step, in situ polymerization process is described for making gel polymer lithium ion rechargeable electrochemical cells. The process includes preparing gel polymer electrolyte precursor solutions consisting of multi-functional monomers or co-monomers, organic plasticizers, and an alkali metal salt, and then thermally curing the precursor solutions in a complete cell package. This greatly simplified process for making gel polymer lithium ion cells results in significantly improved production efficiencies.

These and other objects of the present invention will become increasingly more apparent to those skilled in the art by reference to the appended drawings and the following description.

### BRIEF DESCRIPTION OF DRAWINGS

FIG. 1 is a graph of capacity retention vs. cycle number for the test cell according to the present invention described in Example I.

FIG. 2 is a graph of capacity retention vs. cycle number for the test cell according to the present invention described in Example II.

### DETAILED DESCRIPTION OF THE PREFERRED EMBODIMENTS

The electrochemical cell of the present invention is of a secondary, rechargeable chemistry. The cell comprises an anode active metal selected from Groups IA, IIA and IIIB of the Periodic Table of the Elements, including lithium, sodium, potassium, etc., and their alloys and intermetallic compounds including, for example, Li—Si, Li—Al, Li—B, Li—Mg and Li—Si—B alloys and intermetallic compounds. The preferred metal comprises lithium. An alternate negative electrode comprises a lithium alloy, such as lithium-aluminum alloy. Alloys increase the high temperature operation of such cells. The greater the amount of, for example, aluminum present by weight in the alloy, however, the lower the energy density of the cell.

In conventional secondary electrochemical systems, the anode or negative electrode comprises an anode material capable of intercalating and de-intercalating the anode active material, such as the preferred alkali metal lithium. Typically, the anode material of the negative electrode comprises any of the various forms of carbon (e.g., coke, graphite, acetylene black, carbon black, glassy carbon, etc.) which are capable of reversibly retaining the lithium species. Graphite is particularly preferred in secondary cells. “Hairy carbon” is another particularly preferred material due to its relatively high lithium-retention capacity.

“Hairy carbon” is a material described in U.S. Pat. No. 5,443,928 to Takeuchi et al., which is assigned to the assignee of the present invention and incorporated herein by reference.

Regardless of the carbonaceous nature or makeup of the anode material, fibers are particularly advantageous. Fibers have excellent mechanical properties which permit them to be fabricated into rigid electrode structures capable of withstanding degradation during repeated charge/discharge cycling. Moreover, the high surface area of carbon fibers allows for rapid charge/discharge rates.

The carbonaceous portion of the present negative electrode is fabricated by mixing about 90 to 97 weight percent of an anode material, preferably a carbonaceous material, with about 3 to 10 weight percent of a binder material, which is preferably a fluoro-resin powder such as polytetrafluoroethylene (PTFE), polyvinylidene fluoride (PVDF), polyethylenetetrafluoroethylene (ETFE), polyamides, polyimides, and mixtures thereof. This negative electrode admixture is provided on a current collector such as of a copper, stainless steel, titanium, tantalum, platinum, gold, aluminum, nickel, cobalt nickel alloy, highly alloyed ferritic stainless steel containing molybdenum and chromium, and nickel-, chromium-, and molybdenum-containing alloy foil or screen by casting, pressing, rolling or otherwise contacting the admixture thereto.

Negative electrodes comprising the above described active materials are preferably prepared by a slurry coating method. A preferred negative electrode comprises a carbonaceous powder, such as graphite, mixed with a fluoro-polymeric binder, such as polyvinylidene fluoride (PVDF). This anode active admixture is then mixed with a solvent, such as N-methyl-2-pyrrolidinone (MNP), and the resulting anode active slurry is coated on a copper current collector foil using a doctor-blade. The anode active slurry coated current collector is then dried at an elevated temperature under vacuum.

In a secondary cell, the reaction at the positive electrode involves conversion of ions which migrate from the negative electrode to the positive electrode into atomic or molecular forms. The positive electrode preferably comprises air-stable lithiated active materials including oxides, sulfides, selenides, and tellurides of such metals as vanadium, titanium, chromium, copper, molybdenum, niobium, iron, nickel, cobalt and manganese. The more preferred oxides include LiₓTi₅O₁₂ (x=4 to 7), Li₃₋ₓMₓN (M=Co, Ni; x=0.1 to 0.6), LiNiO₂, LiMn₂O₄, LiMnO₂, LiV₂O₅, LiCoO₂, LiCu_{0.92}Sn_{0.08}O₂ and LiCo₁₋ₓNiₓO₂.

To charge such secondary cells, lithium ions comprising the positive electrode are intercalated into the carbonaceous anode material by applying an externally generated electrical potential to the cell The applied recharging potential draws the lithium ions from the cathode active material, through the electrolyte and into the anode material to saturate it. In the case of carbon, the resulting LiₓC₆ material can have an x ranging between 0.1 and 1.0. The cell is then provided with an electrical potential and discharged in a normal manner.

An alternate secondary cell construction comprises intercalating the carbonaceous anode material with the active lithium material before the negative electrode is incorporated into the cell. In this case, the positive electrode body can be solid and comprise, but not be limited to, such active materials as silver vanadium oxide (SVO), copper silver vanadium oxide (CSVO), Ag₂O, Ag₂O₂, CuF₂, Ag₂CrO₄, MnO₂, V₂O₅, TiS₂, Cu₂S, FeS, FeS₂, CFₓ, copper oxide, copper vanadium oxide, and mixtures thereof. However, this approach is compromised by problems associated with handling lithiated carbon outside the cell. Lithiated carbon tends to react when contacted by air or water.

The above described cathode active materials are formed into a positive electrode by mixing one or more of them with a binder material. Suitable binders are the above described powdered fluoro-polymers, and more preferably powdered polytetrafluoroethylene or powdered polyvinylidene fluoride, present at about 1 to about 5 weight percent of the cathode mixture. Further, up to about 10 weight percent of a conductive diluent is preferably added to the cathode mixture to improve conductivity. Suitable materials for this purpose include acetylene black, carbon black and/or graphite or a metallic powder such as powdered nickel, aluminum, titanium and stainless steel. The preferred cathode active mixture thus includes a powdered fluoro-polymer binder present at about 1 to 5 weight percent, a conductive diluent present at about 1 to 5 weight percent and about 90 to 98 weight percent of the cathode active material.

Positive electrodes for incorporation into an electrochemical cell according to the present invention may be prepared by rolling, spreading or pressing the cathode active formulations onto a suitable current collector of any one of the previously described materials suitable for the negative electrode. The preferred current collector material is aluminum. If desired, the aluminum cathode current collector has a thin layer of graphite/carbon paint applied thereto.

Positive electrodes comprising the above described active materials are preferably prepared by a slurry coating method. A preferred positive electrode comprises a powdered form of one of the above-described lithium transition metal oxides, such as LiCoO₂, LiNiO₂ and LiMn₂O₄, combined with a conductive diluent, such as a carbonaceous material, and a binder to form a cathode slurry. This slurry is coated on an aluminum current collector foil using a doctor blade and dried at an elevated temperature under vacuum.

Positive electrodes prepared as described above may be in the form of one or more plates operatively associated with at least one or more plates of a negative electrode, or in the form of a strip wound with a corresponding strip of the negative electrode in a structure similar to a “jellyroll”. Other electrode assemblies are also contemplated including button and flat batteries.

The electrochemical cell of the present invention further includes a gel polymer electrolyte which serves as a medium for migration of ions between the negative and positive electrodes during electrochemical reactions of the cell. A suitable gel polymer electrolyte is prepared by mixing monomers or co-monomers with a lithium salt, at least one nonaqueous solvent, and a thermal initiator or a free-radical generating activator.

Preferred monomers have at least one α-unsaturated functionality, and more preferably multiple α-unsaturated functionalities, such as multi-functional (meth)acrylates so that they are relatively rapidly curablable inside a cell casing to form a cross-linked matrix or network. Preferably, the (methyl)acryloyl monomer has at least one functional group selected from the group consisting of alkyl, alkyl ether, alkoxylated alkyl and alkoxylated phenol functional groups. Suitable monomers include dipentaerythritol hexaacrylate (DPHA), dipentaerythritol pentaacrylate (DPAA), pentaerythritol tetraacrylate, ethoxylated pentaerythritol tetraacrylate, di(trimethylolpropane) tetraacrylate (DTMPTA), trimethylolpropane trimethacrylate, ethoxylated trimethylolpropane triacrylate (ETMPTA), ethoxylated bisphenol diacrylate, hexanediol diacrylate, and mixtures thereof.

Such cross-linking compounds serve both as a host for ion conducting liquid electrolytes and as a separator in the electrochemical cell. Preferably a co-monomer consisting of two monomers, one of which has lower functionalities, such as difunctionalities, is used to reduce shrinkage and to provide the resulting polymer with flexibility, adhesion, and free volume for ion conducting electrolytes. It is known that monomers with lower functionalities (e.g., two double bonds) and long side chains shrink less during polymerization compared with those with higher functionalities (e.g., six double bonds). For example, use of ethoxylated bisphenol diacrylate as a co-monomer reduces the overall shrinkage in comparison to when DPHA is used alone.

The nonaqueous solvent is of a polar aprotic organic solvent such as cyclic carbonates, cyclic esters, cyclic amides and dialkyl carbonates including ethylene carbonate (EC), propylene carbonate (PC), butylene carbonate (BC), γ-butyrolactone (GBL), ethyl propyl carbonate (EPC), N,N-diethylacetamide, and mixtures thereof. Preferably, a binary solvent mixture is used, such as one of EC/PC.

Known lithium salts that are useful as a vehicle for transport of alkali metal ions between the negative electrode and the positive electrode include LiPF₆, LIBF₄, LiAsF₆, LiSbF₆, LiClO₄, LiO₂, LiAlCl₄, LiGaCl₄, LiC(SO₂CF₃)₃, LiN(SO₂CF₃₎₂, LiSCN, LiO₃SCF₃, LiC₆F₅SO₃, LiO₂CCF₃, LiSO₆F, LiB(C₆H₅)₄, LiCF₃SO₃, and mixtures thereof. Preferably, LiPF₆ in a concentration of from about 0.5M to about 1.5M is dissolved in the organic solvents or co-solvents as an ion conducting liquid electrolyte.

Suitable thermal initiators as free-radical generating compounds include 1,1′-azobis(cyclohexanecarbonitrile) (ACN), benzoyl peroxide (BPO), 4,4-azobis(4-cyanovaleric acid), lauroyl peroxide, 1,1-bis(tert-butylperoxy)cyclohexane, and 1,1-bis(tert-amylperoxy)cyclohexane.

The monomers are present in the gel polymer electrolyte precursor solution in a concentration of about 4% to about 15%, by weight. The concentration of the thermal initiator is about 0.3% to about 1.0%, by weight, of the electrolyte solution. The thusly prepared gel polymer electrolyte precursor solution is a free-flowing liquid of relatively low viscosity.

In order to prevent internal short circuit conditions, the negative electrode is separated from the positive electrode by a suitable separator material. The separator is of electrically insulative material, and the separator material also is chemically unreactive with the anode and cathode active materials and both chemically unreactive with and insoluble in the gel polymer electrolyte. In addition, the separator material has a degree of porosity sufficient to allow flow there through of the electrolyte during the electrochemical reaction of the cell. Illustrative separator materials include fabrics woven from fluoropolymeric fibers including polyvinylidine fluoride, polyethylenetetrafluoroethylene, and polyethylenechlorotrifluoroethylene used either alone or laminated with a fluoropolymeric microporous film, non-woven glass, polypropylene, polyethylene, glass fiber materials, ceramics, polytetrafluoroethylene membrane commercially available under the designation ZITEX (Chemplast Inc.), polypropylene membrane commercially available under the designation CELGARD (Celanese Plastic Company, Inc.) and a membrane commercially available under the designation DEXIGLAS (C.H. Dexter, Div., Dexter Corp.).

A preferred electrode assembly includes the negative and positive electrodes and an intermediate separator of a non-woven fabric and a polypropylene/polyethylene microporous membrane which are each soaked with the gel polymer electrolyte precursor solution. A number of stacked electrode assemblies are combined to form a battery of a desired high voltage or high capacity. The stacked assembly is then sealed in a foil/poly outer bag under vacuum. This assembly is then hermetically sealed in a prismatic or cylindrical metal container or casing. Finally, the cell package is heated in an oven at an elevated temperature for a time sufficient to in situ cure the gel polymer electrolyte precursor solution. Suitable heating temperatures range from about 75° C. to about 85° C. for about 10 minutes to about one hour.

Electrochemical cells prepared according to this invention exhibit a completely cured gel polymer electrolyte devoid of any free-flow liquid and good adhesion exists between the electrodes and the SPE. Such cells are cycleable from about −20° C. to about 50° C.

The following examples describe the structure and processes for providing gel polymer rechargeable electrochemical cells according to the present invention, and they set forth the best mode contemplated by the inventors of carrying out the invention, but they are not to be construed as limiting.

### EXAMPLE I

A polymer electrolyte precursor solution was prepared from, by weight, 8% dipentaerythritol hexaacrylate (DPHA, Nippon Kayaku Co., Ltd.) mixed with a liquid electrolyte solution of 1M LiPF₆ in 2EC:PC, by weight. To this mixture, 0.5%, by weight, of 1,1′-azobis(cyclohexanecarbonitrile) (ACN) as a thermal initiator was added.

Test cell no. 1 was constructed having an negative electrode of, by weight, 91.7% mesocarbon microbeads (MCMB 25-28) and 8.3% PVDF powders mixed with NMP. The resulting anode active slurry was coated on a 10.2 μm thick copper current collector substrate. The positive electrode was formed by mixing powders of, by weight, 91.0% LiCo₂, 3.0% PVDF and 6.0% graphite in a solvent of NMP coated to a thickness of 25.4 μm on an aluminum current collector substrate. The electrode active structures were then dried at 100° C. under vacuum for at least six hours and die-cut to 4.0 cm×6.9 cm (27.6 cm²) to form the negative electrode and to 3.8 cm×6.7 cm (25.5 cm²) to form the positive electrode.

The electrodes, together with a 50.8 μm thick non-woven fabric separator (Nippon Kodoshi Corporation), were soaked with the above-described polymer electrolyte precursor solution and stacked as an anode/fabric/cathode assembly. This stacked electrode assembly was sealed under vacuum in a poly/foil bag and put in an oven heated to about 79° C. for about 16 minutes for in situ polymerization.

After curing, test cell no. 1 was first cycled three times at room temperature between 2.75 V and 4.10 V at a relatively low capacity rate of 0.2C for capacity assessment, followed by one cycle at a 1C rate for rate capability assessment. The 1C capacity rate corresponds to a current density of about 2.75 mA/cm².

Table 1 shows cell capacities at 0.2C and 1C for test cell no. 1. The cell capacity at 0.2C was very close to the expected values based on the amount of active materials contained in the electrodes. The capacity at 1C was 90% of that at 0.2C. A Coulombic efficiency of 99% was observed.

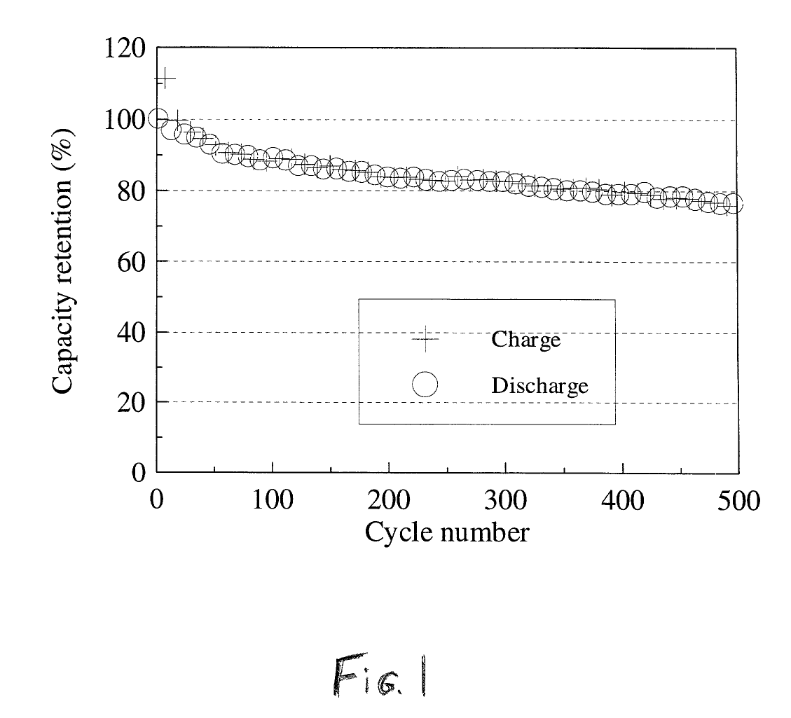

FIG. 1 is a graph illustrating capacity retention vs. cycle number for test cell no. 1. To construct this graph, the cell was cycled between 2.75 V and 4.20 V at a rate of 0.4C (1.10 mA/cm 2) at room temperature. Under these test conditions, the cell cycled 380 times before reaching 80% capacity retention. Upon further cycling, the cell capacity decreased very slowly. At 500 cycles, the cell capacity was at about 77% of its initial value. Cycling between 2.75 V and 4.20 V gives more capacity than cycling between 2.75 V and 4.10 V. Cycling between 2.75 V and 4.10 V gives longer cell cycling life.

TABLE 1

| Test | | Cap. | 1C Cap. | | |
|---|---|---|---|---|---|
| Cell | Polymer | (mAh, @ | (%, vs. | Coulombic | |
| No. | elec. | 0.2C) | 0.2C) | eff. | Mono. |
| 1 | 8% DPHA | 57.7^{a} | 90.3% | 0.991 | DPHA |
| | 0.5% ACN | | | | |
| 2 | 8% DPPA | 70.2^{b} | 93.7% | 0.955 | DPAA |
| | 0.5% ACN | | | | |
| 3 | 8% ETMPTA | 70.4^{b} | 91.1% | 0.986 | ETMPTA |
| | 0.5% ACN | | | | |

^{a}Charged to 4.1 V
^{b}Charged to 4.2 V

### EXAMPLE II

A polymer electrolyte precursor solution was prepared from, by weight, 8% dipentaerythritol pentaacrylate (DPAA, Sartomer Company) mixed with a liquid electrolyte solution of 1M LiPF₆ in 2EC:PC. ACN (0.5%) was added to this mixture as a thermal initiator.

Test cell no. 2 had electrodes of active material formulations prepared using an in situ polymerization method the same as that described in Example I. This cell was cycled three times at room temperature between 2.75 V and 4.20 V at a rate of 0.2C, followed by one cycle at 1C. Table 1 shows cell capacities at 0.2 and 1C. The capacity at 1C was 94% of that at 0.2C. A Coulombic efficiency of 96% was observed.

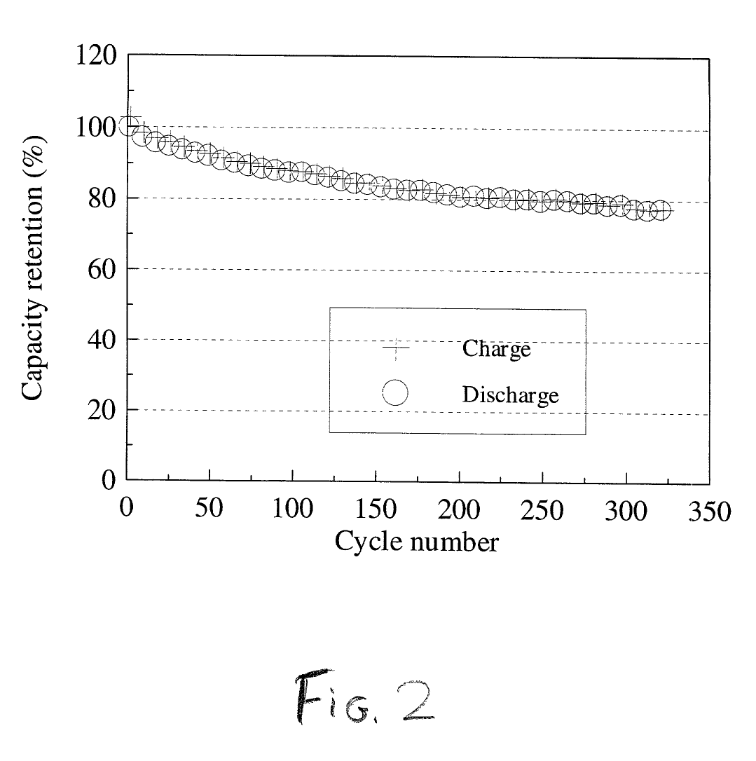

FIG. 2 is a graph illustrating the capacity retention vs. cycle number for test cell no. 2. To construct this graph, the cell was cycled between 2.75 and 4.20 V at 0.4C. This is a moderate rate, long term cyclability test. The cell retained 80% of its initial capacity after 230 cycles. The cell capacity then decreased very slowly upon further cycling. At 320 cycles, the capacity retained 77.5% of its initial value.

### EXAMPLE III

A polymer electrolyte precursor solution was prepared from, by weight, 8% of ethoxylated trimethylolpropane triacrylate (ETMPTA, Sartomer Company) mixed with a liquid electrolyte solution of 1M LiPF₆ in 2EC:PC. ACN (0.5%) was added to this mixture as a thermal initiator.

Test cell no. 3 had electrodes of active material formulations prepared using an in situ polymerization method the same as that described in Example I. The cell was cycled three times at room temperature between 2.75 V and 4.20 V at 0.2C, followed by one cycle at 1C. Table 1 shows capacities at 0.2 and 1C for this cell. The capacity at 1C was 91% of that at 0.2C. A 99% Coulombic efficiency was observed.

### EXAMPLE IV

Polymer electrolyte precursor solutions were prepared from, by weight, 8% di(trimethylolpropane) tetraacrylate (DTMPTA, Sartomer Company) mixed with a liquid electrolyte solution of 1M LiPF₆ in 2EC:PC. ACN as a thermal initiator was added to this solutions in by weight percentages of 0.32%, 0.48% and 0.64%, respectively. The resulting polymer electrolyte precursor solutions were then used to build test cell nos. 4a, 4b and 4c. This is shown in Table 2.

Test cell nos. 4a to 4c had electrodes of active material formulations prepared using an in situ polymerization method the same as that described in Example I. The test cells were cycled three times at room temperature between 2.75 V and 4.20 V at 0.2C, followed by one cycle at 1C Table 3 shows cell capacities at 0.2 and 1C. The capacities at 1C for all the cells in Example IV were very close to or above 90% of those at 0.2C. Of the three cells in this example, test cell 4b demonstrated the highest 1C capacity, 93%, and the largest Coulombic efficiency, 99%.

TABLE 2

| | Polymer | | | |
|---|---|---|---|---|
| Test | electrolyte | Capacity | 1C Cap | |
| Cell | 8% DTMPTA | (mAh, @ | (%, vs. | Coulombic |
| No. | and | 0.2C) | 0.2C) | efficiency |
| 4a | 0.32% ACN | 71.9 | 89.4% | 0.932 |
| 4b | 0.48% ACN | 72.3 | 93.3% | 0.987 |
| 4c | 0.64% ACN | 69.1 | 83.3% | 0.961 |

### EXAMPLE V

Polymer electrolyte precursor solutions were prepared from, by weight, 8% of co-monomers consisting of ethoxylated trimethylolpropane triacrylate (ETMPTA) and di(trimethylolpropane) tetraacrylate (DTMPTA) mixed with a liquid electrolyte solution of 1M LiPF6 in 2EC:PC. The weight ratios of ETMPTA/DTMPTA were 3:1, 1:1 and 1:3 for the polymer electrolyte precursor solutions used in test cells nos. 5a, 5b and 5c, respectively. To the above solutions, 0.5% ACN as a thermal initiator was added.

Test cell nos. 5a to 5c had electrodes of active material formulations prepared using an in situ polymerization method the same as that described in Example I. The cells were cycled three times at room temperature between 2.75 V and 4.20 V at 0.2C, followed by one cycle at 1C. Table 3 shows cell capacities at 0.2 and 1C. The capacities at 1C for each of the test cells in this example were above 90% of that at 0.2C, and the Coulombic efficiencies were larger than 98%.

TABLE 3

| | Polymer elec. | | | |
|---|---|---|---|---|
| Test | (8% co-monomers; | Capacity | 1C Cap | |
| Cell | 0.5% ACN) | (mAh, @ | (%, vs. | Coulombic |
| No. | ETMPTA:DTMPTA = | 0.2C) | 0.2C) | eff. |
| 5a | 3:1 | 70.3 | 90.3% | 0.982 |
| 5b | 1:1 | 72.3 | 91.2% | 0.987 |
| 5c | 1:3 | 68.5 | 90.5% | 0.988 |

The above examples clearly set forth that gel polymer rechargeable cells prepared according to this invention demonstrated good chemical and electrochemical stabilities, high efficiency in material utilization, high Coulombic efficiency, good rate capability, and high capacity retention upon cycling.

It is appreciated that various modifications to the present inventive concepts described herein may be apparent to those of ordinary skill in the art without disporting from the spirit and scope of the present invention as defined by the herein appended claims.

What is claimed is:

1. An electrochemical cell, comprising:
a) an electrolyte comprising at least one monomer having at least one a-unsaturated functionality and a thermal initiator mixed with an alkali metal salt and at least one organic solvent;
b) a casing;
c) a negative electrode comprising an anode active material contacted to an anode current collector;
d) a positive electrode comprising a cathode active material contacted to a positive current collector; and
e) a separator, wherein the negative electrode, the positive electrode and the intermediate separator are characterized as having been soaked in the electrolyte to provide an electrode assembly housed in the casing and heated to provide the electrochemical cell.

2. The electrochemical cell of claim 1 wherein the at least one monomer has more than one a-unsaturated functionality.

3. The electrochemical cell of claim 1 wherein the at least one monomer has more than one (methyl)acryloyl functionality.

4. The electrochemical cell of claim 3 wherein the (methyl)acryloyl monomer has at least one functional group selected from the group consisting of alkyl, alkyl ether, alkoxylated alkyl and alkoxylated phenol functional groups.

5. The electrochemical cell of claim 1 wherein the monomer is selected from the group consisting of dipentaerythritol hexaacrylate, dipentaerythritol pentaacrylate, pentaerythritol tetraacrylate, ethoxylated pentaerythritol tetraacrylate, di(trimethylolpropane) tetraacrylate, trimethylolpropane trimethacrylate, ethoxylated trimethylolpropane triacrylate, ethoxylated bisphenol diacrylate, hexanediol diacrylate, and mixtures thereof.

6. The electrochemical cell of claim 1 wherein the monomer is present in the electrolyte in a concentration of about 4% to about 15%, by weight.

7. The electrochemical cell of claim 1 including selecting the organic solvent from the group consisting of ethylene carbonate, propylene carbonate, butylene carbonate, γ-butyrolactone, ethyl propyl carbonate, N,N-diethylacetamide, and mixtures thereof.

8. The electrochemical cell of claim 1 wherein the initiator is selected from the group consisting of 1,1′-azobis(cyclohexanecarbonitrile), benzoyl peroxide, 4,4-azobis(4-cyanovaleric acid), lauroyl peroxide, 1,1-bis(tert-butylperoxy)cyclohexane, 1,1-bis(tert-amylperoxy)cyclohexane, and mixtures thereof.

9. The electrochemical cell of claim 1 wherein the initiator is present in the electrolyte in a concentration of, by weight, about 0.3% to about 1%.

10. The electrochemical cell of claim 1 wherein the alkali metal salt is selected from the group consisting of LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)4, LiCF₃SO₃, and mixtures thereof.

11. The electrochemical cell of claim 1 wherein the cell is characterized as having been heated to a temperature ranging from about 75° C. to about 85° C.

12. The electrochemical cell of claim 1 wherein the cell is characterized as having been heated for about 10 minutes to about one hour.

13. The electrochemical cell of claim 1 wherein the anode active material is selected from the group consisting of coke, graphite, acetylene black, carbon black, glassy carbon, hairy carbon, and mixtures thereof.

14. The electrochemical cell of claim 1 wherein the cathode active material is selected from the group consisting of oxides, sulfides, selenides, and tellurides of vanadium, titanium, chromium, copper, molybdenum, niobium, iron, nickel, cobalt, manganese, and mixtures thereof.

15. An electrochemical cell, comprising:
a) an electrolyte comprising at least one monomer having at least one α-unsaturated functionality and a thermal initiator mixed with an alkali metal salt and at least one organic solvent;
b) a casing;
c) a negative electrode comprising an anode active material selected from the group consisting of coke, graphite, acetylene black, carbon black, glassy carbon, hairy carbon, and mixtures thereof contacted to an anode current collector;
d) a positive electrode comprising a cathode active material selected from the group consisting of LiₓTi₅O₁₂ (x=4 to 7), Li₃₋ₓMₓN (M=Co, Ni; x=0.1 to 0.6), LiNiO₂, LiMn₂O₄, LiMnO₂, LiV₂O₅, LiCoO₂, LiCu_{0.92}Sn_{0.08}O₂, LiCo₁₋ₓNiₓO₂, SVO, CSVO, Ag₂O, Ag₂O₂, CuF₂, Ag₂CrO₄, MnO₂, V₂O₅, TiS₂, Cu₂S, FeS, FeS₂, CFₓ, copper oxide, copper vanadium oxide, and mixtures thereof contacted to a positive current collector; and
e) a separator, wherein the negative electrode, the positive electrode and the intermediate separator are characterized as having been soaked in the electrolyte to provide an electrode assembly housed in the casing and heated to provide the electrochemical cell.

16. A method for providing an electrochemical cell, comprising the steps of:
a) providing a negative electrode comprising an anode active material contacted to an anode current collector;
b) providing a positive electrode comprising a cathode active material contacted to a positive current collector;
c) providing a separator;
d) preparing an electrolyte comprising at least one monomer having at least one a-unsaturated functionality and a thermal initiator mixed with an alkali metal salt and at least one organic solvent;
e) soaking the negative electrode, the positive electrode and the intermediate separator in the electrolyte to provide an electrode assembly;
f) housing the electrode assembly in a casing; and
g) heating the casing housing the electrode assembly to provide the electrochemical cell.

17. The method of claim 16 wherein the at least one monomer has more than one α-unsaturated functionality.

18. The method of claim 16 wherein the at least one monomer has more than one (methyl)acryloyl functionality.

19. The method of claim 18 wherein the (methyl)acryloyl monomer has at least one functional group selected from the group consisting of alkyl, alkyl ether, alkoxylated alkyl and alkoxylated phenol functional groups.

20. The method of claim 16 including selecting the monomer from the group consisting of dipentaerythritol hexaacrylate, dipentaerythritol pentaacrylate, pentaerythritol tetraacrylate, ethoxylated pentaerythritol tetraacrylate, di(trimethylolpropane) tetraacrylate, trimethylolpropane trimethacrylate, ethoxylated trimethylolpropane triacrylate, ethoxylated bisphenol diacrylate, hexanediol diacrylate, and mixtures thereof.

21. The method of claim 16 including providing the monomer in a concentration of about 4% to about 15%, by weight, of the electrolyte.

22. The method of claim 16 including selecting the organic solvent from the group consisting of cyclic carbonates cyclic esters, cyclic amides, dialkyl carbonates, and mixtures thereof.

23. The method of claim 16 including selecting the organic solvent from the group consisting of ethylene carbonate, propylene carbonate, butylene carbonate, γ-butyrolactone, ethyl propyl carbonate, N,N-diethylacetamide, and mixtures thereof.

24. The method of claim 16 including providing the organic solvent as a mixture of ethylene carbonate and propylene carbonate.

25. The method of claim 16 including selecting the initiator from the group consisting of 1,1′-azobis(cyclohexanecarbonitrile), benzoyl peroxide, 4,4-azobis(4-cyanovaleric acid), lauroyl peroxide, 1,1-bis(tert-butylperoxy)cyclohexane, 1,1-bis(tert-amylperoxy)cyclohexane, and mixtures thereof.

26. The method of claim 16 including providing the initiator in a concentration of about 0.3% to about 1%, by weight, of the electrolyte.

27. The method of claim 16 including selecting the alkali metal salt from the group consisting of LiPF₆, LiBF₄, LiAsF₆, LiSbF₆, LiClO₄, LiO₂, LiAlCl₄, LiGaCl₄, LiC(SO₂CF₃)₃, LiN(SO₂CF₃)₂, LiSCN, LiO₃SCF₃, LiC₆F₅SO₃, LiO₂CCF₃, LiSO₆F, LiB(C₆H₅)₄, LiCF₃SO₃, and mixtures thereof.

28. The method of claim 16 including heating the casing to a temperature ranging from about 75° C. to about 85° C.

29. The method of claim 16 including heating the casing for about 10 minutes to about one hour.

30. The method of claim 16 including selecting the anode active material from the group consisting of coke, graphite, acetylene black, carbon black, glassy carbon, hairy carbon, and mixtures thereof.

31. The method of claim 16 including selecting the anode current collector from the group consisting of copper, stainless steel, titanium, tantalum, platinum, gold, aluminum, nickel, cobalt nickel alloy, highly alloyed ferritic stainless steel containing molybdenum and chromium, and nickel-, chromium-, and molybdenum-containing alloy.

32. The method of claim 16 including selecting the cathode active material from the group consisting of oxides, sulfides, selenides, and tellurides of vanadium, titanium, chromium, copper, molybdenum, niobium, iron, nickel, cobalt and manganese.

33. The method of claim 16 including selecting the cathode active material from the group consisting of LiₓTi₅O₁₂ (x=4 to 7), Li₃₋ₓMₓN (M=Co, Ni; x=0.1 to 0.6), LiNiO₂, LiMn₂O₄, LiMnO₂, LiV₂O₅, LiCoO₂, LiCu_{0.92}Sn_{0.08}O₂, LiCo₁₋ₓNiₓO₂, and mixtures thereof.

34. The method of claim 16 including selecting the cathode current collector from the group consisting of copper, stainless steel, titanium, tantalum, platinum, gold, aluminum, nickel, cobalt nickel alloy, highly alloyed ferritic stainless steel containing molybdenum and chromium, and nickel-, chromium-, and molybdenum-containing alloy.
